(19) United States
(12) Patent Application Publication
(10) Pub. No.: US 2008/0309928 A1
(43) Pub. Date: Dec. 18, 2008

(54) Automatic Optical Inspection Device, Chip Sorting Apparatus and Method

(76) Inventor: Hsin Hui Han, Taipei (TW)

Correspondence Address: STOUT, UXA, BUYAN & MULLINS LLP, 4 VENTURE, SUITE 300, IRVINE, CA, 92618, US

(21) Appl. No.: 11/854,992

(22) Filed: Sep. 13, 2007

(30) Foreign Application Priority Data
Jun. 15, 2007 (TW) 096121931

(51) Int. Cl. G01N 21/00

(52) U.S. Cl. 356/237.2

(57) ABSTRACT

An automatic optical inspection device for inspecting the surface defects of integrated circuits is disclosed in this invention. The automatic optical inspection device includes a tray transporting device which transports a tray carrying at least one integrated circuit and having at least one clip area, a press mechanism for fixing the tray to the tray transporting device by clamping the clip area of the tray, and an image capture device for capturing an image of one surface of the integrated circuit. The surface defects of the integrated circuit can be found by analyzing the image. Chip sorting apparatus and method are also disclosed in this invention. The chip sorting apparatus includes a pick-and-place head which picks a chip on a wafer and places the chip on a tray; and an image capture device which is disposed for examining the chip surface of the chip so as to find the surface defects of the chip. The method includes transferring a chip on a wafer to a tray by a pick-and-place head; and examining the chip surface of the chip by an image capture device.

### BACKGROUND OF THE INVENTION

1. Field of the Invention

The present invention generally relates to an automatic optical inspection device, and more particularly to an automatic optical inspection device for inspecting the surface defects of integrated circuits.

2. Description of the Prior Art

In the semiconductor device production process, the wafer test process is performed before the wafer dicing process by the automatic test equipment (ATE) to ensure the quality of electrical characteristics of the semiconductor device. After the wafers are divided into chips, a chip sorter is used to pick up and place the chips on trays. Then trays are transferred to the following process equipment.

In the pick-and-place process of the chips performed by the pick-and-place head, the pick-and-place head will touch the chip surface of the chip. If the contact force between the pick-and-place head and the chip is too big, the chip surface will be scratched by the pick-and-place head. Or the pick-and-place head will be worn after several times of the pick-and-place process, and the pick-and-place head will leave particles on the chip surface. In order to confirm the quality of the chips, it is necessary to inspect the chips carried on the tray by the optical inspection operator before the following process. The general surface defect include scratch, particle, bump touch defect and so on.

However, the quality of chips on the tray inspected by the optical inspection operator is not stable. Because different operators have different judgments on the defects, the quality of chips which passes in the optical inspection is unstable. And because the efficiency of the optical inspection performed by the optical inspection operator is not enough to inspect every chip carried on the tray, the chips of bad quality will be loaded into the following process equipment.

For the reason that there are some disadvantages of the conventional optical inspection by operator mentioned above, a need has arisen to propose a novel automatic optical inspection device not only for inspecting the surface defects of chips, but also for inspecting the surface defects of general integrated circuits, to solve the problems that the quality of chips on the tray inspected by the optical inspection operator is not stable, and increase the efficiency of optical inspection.

### SUMMARY OF THE INVENTION

Accordingly, the present invention has been made in order to meet such a need described above, and it is an object of the present invention to provide an automatic optical inspection device not only for inspecting the surface defects of chips, but also for inspecting the surface defects of general integrated circuits, to solve the problems that the quality of chips on the tray inspected by the optical inspection operator is not stable, and increase the efficiency of optical inspection.

In order to achieve the above objects, the present invention provides an automatic optical inspection device for inspecting the surface defects of integrated circuits. The automatic optical inspection device includes a tray transporting device which transports a tray carrying at least one integrated circuit and having at least one clip area, a press mechanism disposed on the tray transporting device to fix the tray to the tray transporting device by clamping the clip area of the tray, and an image capture device disposed above the tray transporting device to capture an image of one surface of the integrated circuit. The surface defects of the integrated circuit can be found by analyzing the image.

### BRIEF DESCRIPTION OF THE DRAWINGS

FIG. 1A shows the schematic top view of an automatic optical inspection device in accordance with the first preferred embodiment of the present invention;

FIG. 1B shows the schematic top view of an automatic optical inspection device in accordance with the second preferred embodiment of the present invention;

FIG. 2 shows a schematic cross-sectional view of an automatic optical inspection device shown in FIG. 1;

FIG. 3 shows the schematic top view of a chip sorting apparatus in accordance with a preferred embodiment of the present invention;

FIG. 4 shows a schematic diagram of an image capture device shown in FIG. 3; and

FIG. 5 shows the flow diagram of a chip sorting method in accordance with a preferred embodiment of the present invention.

### DETAILED DESCRIPTION OF THE INVENTION

The detailed description of the present invention will be discussed in the following embodiments, which are not intended to limit the scope of the present invention, but can be adapted for other applications. While drawings are illustrated in details, it is appreciated that the quantity of the disclosed components may be greater or less than that disclosed, except expressly restricting the amount of the components.

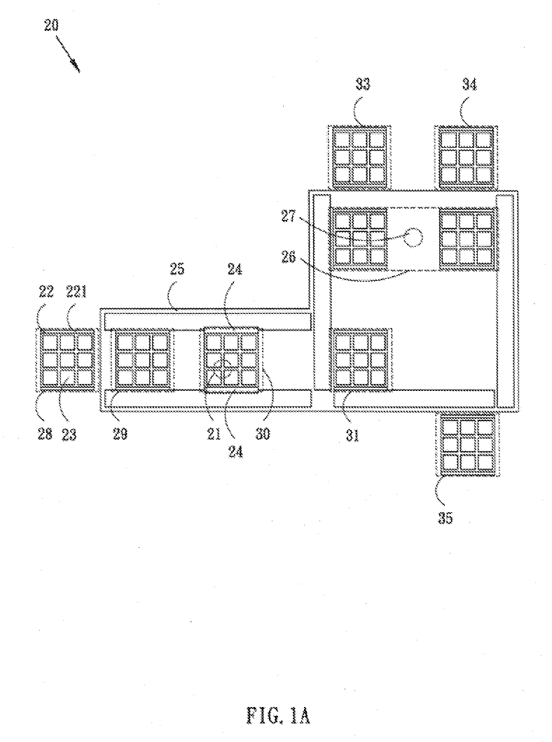

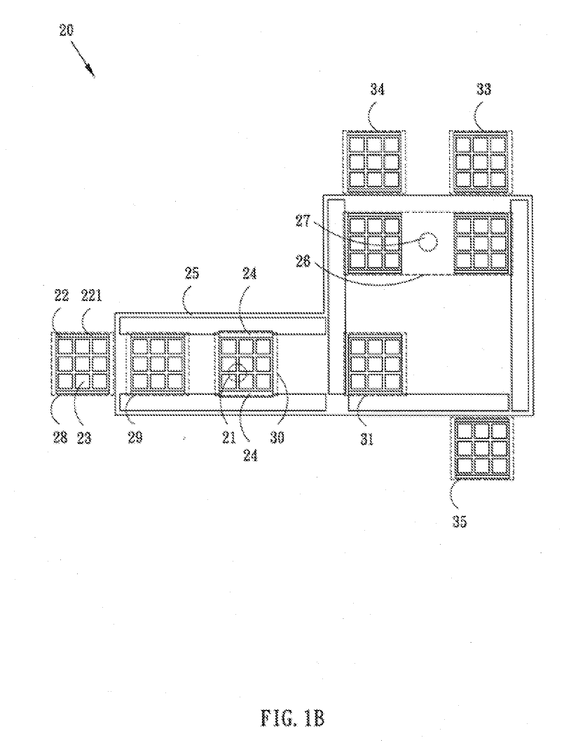

FIG. 1A shows the schematic top view of an automatic optical inspection device in accordance with the first preferred embodiment of the present invention. The automatic optical inspection device 20 for inspecting the surface defects of integrated circuits 23 includes a tray transporting device 25, a press mechanism 24, and an image capture device 21.

The tray transporting device 25 is used for transporting a tray 22 carrying at least one integrated circuit 23, and the tray 22 has at least one clip area 221. The tray transporting device 25 also includes a buffer area 29, an inspecting area 30, a sorting buffer area 31, and a sorting area 26. The tray transporting device 25 further includes a loading tray stacking device 28, a tray stacking device 35, a pass tray stacking device 33, and a fail tray stacking device 34.

The press mechanism 24 is used for fixing the tray 22 to the tray transporting device 25 by clamping the clip area 221.

The image capture device 21 is used for capturing an image of one surface of the integrated circuit 23. The image capture device 21 is a CCD (Charge Coupled Device) sensor in this embodiment. However, the image capture device 21 can be other type of sensor.

The surface defects of the integrated circuit 23 are able to be found by analyzing the image by a computer (not shown), and the positions of the surface defects are recorded in the computer. The process and principle for analyzing the image by a computer is not described there. In this embodiment, the minimum dimension of the surface defects is about 5 um which is enough to inspect the general surface defects, for example, scratch, particle, bump touch defect and so on.

The loading tray stacking device 28 is used for storing the tray 22 which carries the integrated circuit 23 waiting for inspection. The buffer area 29 is disposed between the loading tray stacking device 28 and the inspecting area 30. The integrated circuit 23 is waiting for inspection within the buffer area 29 so as to decrease the transferring time of the tray 22.

The inspecting area 30 has the press mechanism 24 and the image capture device 21. The press mechanism 24 fixes the tray 22 to the tray transporting device 25, and then the image capture device 21 inspects the integrated circuit 23 on the tray 22.

The sorting buffer area 31 is disposed between the inspecting area 30 and the tray stacking device 35, the integrated circuit 23 inspected is waiting for being sorted within the sorting buffer area 31 so as to decrease the transferring time of the tray 22. The tray stacking device 35 is used for providing the tray 22 to the sorting area 26.

The sorting area 26 is disposed between the sorting buffer area 3 1, the pass tray stacking device 33, and the fail tray stacking device 34. The sorting area 26 has a pick-and-place head 27 controlled by the computer which analyzes the image. Because the computer has recorded the positions of the integrated circuit 23 which has the surface defects, the pick-and-place head 27 is able to place the integrated circuit 23 passed in the optical inspection and the integrated circuit 23 failed in the optical inspection to different trays 22. And then the tray 22 which carries the integrated circuit 23 passed is transferred to the pass tray stacking device 33, the tray 22 which carries the integrated circuit 23 failed is transferred to the fail tray stacking device 34.

In this embodiment, by the control of the computer mentioned above, the pick-and-place head 27 is able to transfer the integrated circuit 23 failed to the tray 22 which carries the integrated circuit 23 failed. And the pick-and-place head 27 is able to transfer the integrated circuit 23 passed from the next tray 22 to the tray 22 which carries the integrated circuit 23 passed. So as to fill up the tray 22 which carries the integrated circuit 23 passed for the convenience of the following process, but not limited to this.

FIG. 1B shows the schematic top view of an automatic optical inspection device in accordance with the second preferred embodiment of the present invention. In this embodiment, by the control of the computer mentioned above, the pick-and-place head 27 is able to transfer the integrated circuit 23 passed to the tray 22 which carries the integrated circuit 23 passed so as to fill up the tray 22 which carries the integrated circuit 23 passed for the convenience of the following process, but not limited to this.

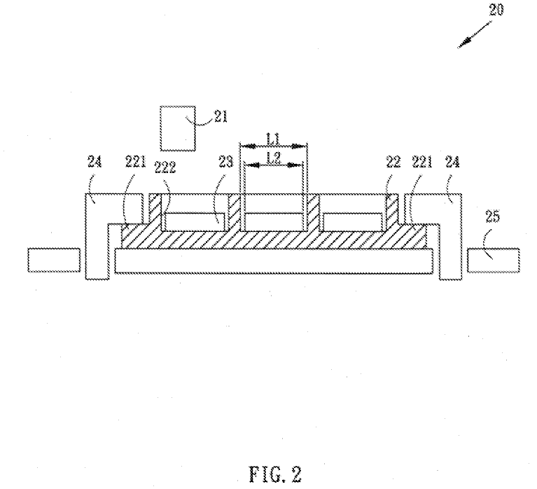

FIG. 2 shows a schematic cross-sectional view of an automatic optical inspection device shown in FIG. 1. The integrated circuit 23 is placed within the cave 222 on the tray 22. If the clearance between the integrated circuit 23 and the cave 222 is too big, there will be wrong judgments happened in the analysis of the surface image by the automatic optical inspection device 20. In this embodiment, in order to avoid the clearance between the integrated circuit 23 and the cave 222 being too big, the minimum length L1 of the cave 222 is bigger than the maximum length L2 of the integrated circuit 23 about 0.05 mm. And the tray 22 has a flatness tolerance less than 0.05 mm.

By using the automatic optical inspection device for inspecting the surface defects of integrated circuits of the present invention, it is possible to solve the problem that the quality of chips on the tray inspected by the optical inspection operator is not stable, and because the efficiency of automatic optical inspection device is high, it is possible to inspect every chip to avoid the chip with surface defects loaded into the following process equipment.

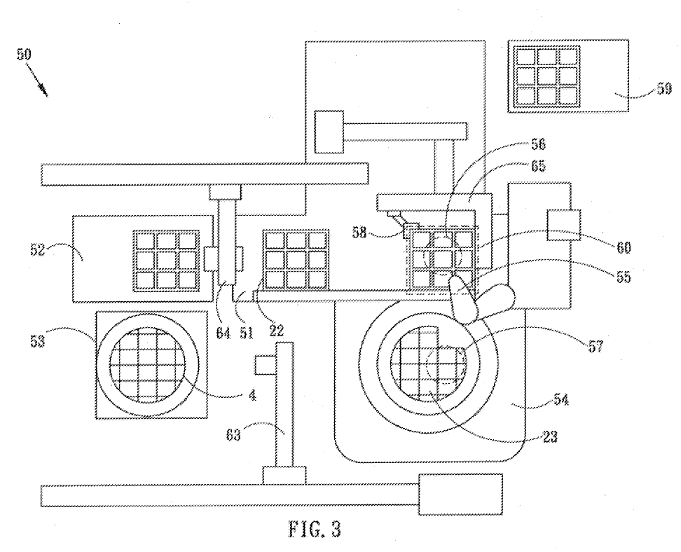

FIG. 3 shows the schematic top view of a chip sorting apparatus in accordance with a preferred embodiment of the present invention. The chip sorting apparatus 50 includes a tray transporting device 51, a pick-and-place head 55, and an image capture device 56.

The tray transporting device 51 has a transporting lever 65 for transferring a tray 22. The tray transporting device 51 also has a tray fixing device so as to fix the tray 22 in the position convenient for the chip 23 picking and placing. The pick-and-place head 55 is disposed for picking a chip 23 on a wafer 4 and placing the chip 23 on the tray 22. The image capture device 56 is used for examining a chip surface of the chip 23 so as to find surface defects of the chip 23. In this embodiment the image capturing region 60 of the image capture device 56 contains the whole tray 22 so as to achieve an image of the whole tray 22 by one image capturing process.

The chip sorting apparatus 50 in this embodiment also includes a tray loading device 52 and a tray stacking device 59. The tray loading device 52 is used for exporting a tray 22 to the tray transporting device 51. The tray stacking device 59 is used for storing the tray 22 exported from the tray transporting device 51. The tray loading device 52 exports a tray 22 to the tray transporting device 51 by a transporting lever 64.

The chip sorting apparatus 50 in this embodiment also includes a wafer stage 54 and a wafer loading device 53. The wafer stage 54 is used for carrying the wafer 4. The wafer loading device 53 is used for exporting the wafer 4 to the wafer stage 54. The wafer loading device 53 exports the wafer 4 to the wafer stage 54 by a transporting lever 63. An image capture device 57 is also able to be disposed above the wafer stage 54.

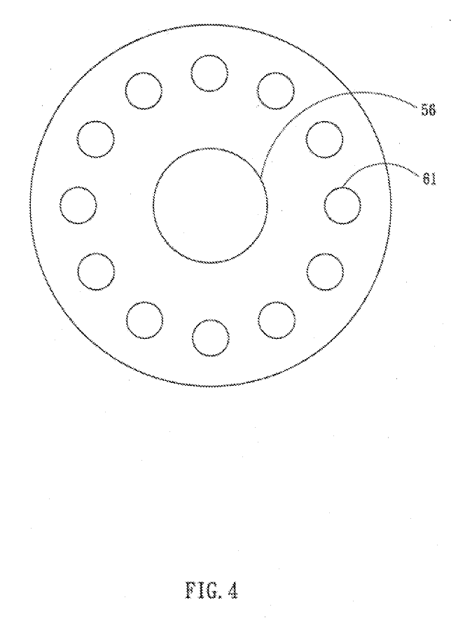

FIG. 4 shows a schematic diagram of an image capture device shown in FIG. 3. The image capture device 56 is a CCD (Charge Coupled Device) sensor in this embodiment. The pixel number of the image capture device 56 is 1.3 million, but not limited to this. However, the image capture device 56 can be other type of sensor, for example a CMOS sensor (Complementary Metal-Oxide-Semiconductor). In order to capture an image of good quality, the chip sorting apparatus 50 in this embodiment also includes an auxiliary light source 61 disposed around the image capture device 56 so as to light up the chip surface of the chip 23. In this embodiment, the auxiliary light source 61 is composed of a plurality of blue LEDs, but not limited to this.

The surface defects of the chip 23 are able to be found by analyzing the image by a computer (not shown). When the surface defects of the chip 23 are found, the computer is able to stop the process of the pick-and-place head 55, and the computer will send a signal to call operators to check the quality of the chip 23 and the condition of the pick-and-place head 55. The process and principle for analyzing the image by a computer is the AOI technology. The AOI technology is not described there. In this embodiment the image capturing region 60 of the image capture device 56 contains the whole tray 22, when the computer analyzes the image, the dimension of the tray 22 and the positions where the chip 22 placed in can be judged by the computer so as to save the setting time of the chip sorting apparatus.

By using the chip sorting apparatus of the present invention, the surface defects of a chip placed on a tray are detected by an image capture device, it is possible to solve the problem that the quality of chips on the tray inspected by the optical inspection operator is not stable, save the setting time of the chip sorting apparatus, and stop the pick-and-place process of the chips performed by the pick-and-place head in bad condition to avoid the chip being damaged by the pick-and-place head. Therefore it is possible to avoid the chip with surface defects loaded into the following process equipment.

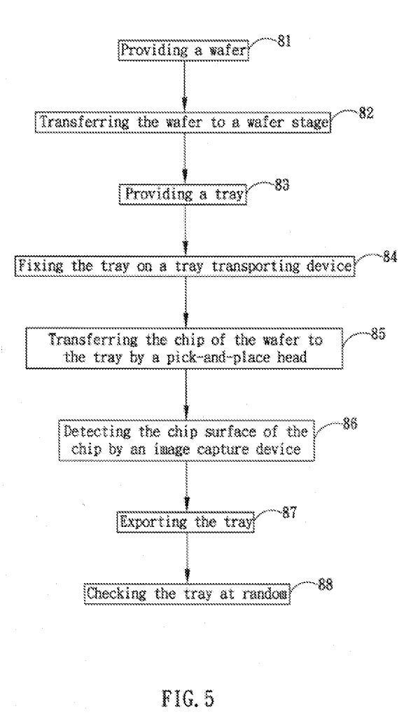

FIG. 5 shows the flow diagram of a chip sorting method in accordance with a preferred embodiment of the present invention. The chip sorting method includes following steps: the step 81 shows providing a wafer, the wafer has been cut to a plurality of chips; the step 82 shows transferring the wafer to a wafer stage, the wafer stage is used for carrying the wafer; the step 83 shows providing a tray, the tray has a plurality of caves for placing the chip; the step 84 shows fixing the tray on a tray transporting device; the step 85 shows transferring the chip of the wafer to the cave of the tray by a pick-and-place head; the step 86 shows detecting the chip surface of the chip by an image capture device; the step 87 shows exporting the tray, in this embodiment the tray is able to be exported to a tray stacking device so as to save the storage room.

The surface defects of the chip are able to be found by analyzing the image by a computer. When the surface defects of the chip are found, the computer is able to stop the process of the pick-and-place head, and the computer will send a signal to call operators to check the quality of the chip and the condition of the pick-and-place head. The process and principle for analyzing the image by a computer is the AOI technology. The AOI technology is not described there.

The chip sorting method mentioned above can also includes a step 88, the step 88 shows checking the tray at random by the optical inspection operator. Because the chip surface of the chip on the tray has been inspected by the image capture device, the sampling rate of the optical inspection can be reduced; the human inspection cost can be saved.

By using the chip sorting method of the present invention, the surface defects of a chip placed on a tray are detected by an image capture device, it is possible to solve the problem that the quality of chips on the tray inspected by the optical inspection operator is not stable, and stop the pick-and-place process of the chips performed by the pick-and-place head in bad condition to avoid the chip being damaged by the pick-and-place head.

Although specific embodiments have been illustrated and described, it will be appreciated by those skilled in the art that various modifications may be made without departing from the scope of the present invention, which is intended to be limited solely by the appended claims.

What is claimed is:

1. An automatic optical inspection device for inspecting the surface defects of integrated circuits, said automatic optical inspection device comprising:
a tray transporting device for transporting a tray carrying at least one integrated circuit, said tray having at least one clip area;
a press mechanism for fixing said tray to said tray transporting device by clamping said clip area of said tray; and
an image capture device for capturing an image of one surface of said integrated circuit, wherein surface defects of said integrated circuit are able to be found by analyzing said image.

2. The automatic optical inspection device according to claim 1, wherein said tray has a flatness tolerance, said flatness tolerance is less than 0.05 mm.

3. The automatic optical inspection device according to claim 1, wherein said tray has a plurality of caves for placing said integrated circuit, the minimum length of said cave is bigger than the maximum length of said integrated circuit about 0.05 mm.

4. The automatic optical inspection device according to claim 1, wherein said image capture device is a CCD (Charge Coupled Device).

5. The automatic optical inspection device according to claim 1, wherein said tray transporting device has an inspecting area, said integrated circuit is inspected by said image capture device within said inspecting area.

6. The automatic optical inspection device according to claim 5, further comprising a loading tray stacking device for storing said tray.

7. The automatic optical inspection device according to claim 6, wherein said tray transporting device further comprises a buffer area, said buffer area is disposed between said loading tray stacking device and said inspecting area, said integrated circuit is waiting for being inspected within said buffer area.

8. The automatic optical inspection device according to claim 5, further comprising a tray stacking device for providing said tray to said tray transporting device.

9. The automatic optical inspection device according to claim 8, wherein said tray transporting device further comprises a sorting buffer area, said sorting buffer area is disposed between said inspecting area and said tray stacking device, said integrated circuit inspected is waiting for being sorted within said sorting buffer area.

10. The automatic optical inspection device according to claim 9, wherein said tray transporting device further comprises a sorting area, said sorting area has a pick-and-place head for placing said integrated circuit passed and said integrated circuit failed to different said tray, and said pick-and-place head is able to fill up said tray carrying said integrated circuit passed by the control of a computer.

11. The automatic optical inspection device according to claim 10, further comprising a pass tray stacking device for storing said tray, wherein each of said integrated circuit carried on said tray passes in the optical inspection.

12. The automatic optical inspection device according to claim 10, further comprising a fail tray stacking device for storing said tray, wherein each of said integrated circuit carried on said tray fails in the optical inspection.

13. A chip sorting apparatus comprising:
a pick-and-place head for picking a chip on a wafer and placing said chip on a tray; and
an image capture device for examining a chip surface of said chip so as to find surface defects of said chip.

14. The chip sorting apparatus according to claim 13, wherein said image capture device is a CCD (Charge Coupled Device).

15. The chip sorting apparatus according to claim 14, wherein said CCD has 1.3 million pixels.

16. The chip sorting apparatus according to claim 13, further comprises an auxiliary light source disposed around said image capture device so as to light up said chip surface.

17. The chip sorting apparatus according to claim 16, wherein said auxiliary light source is a LED light source.

18. The chip sorting apparatus according to claim 17, wherein said LED light source is a blue light source.

19. A chip sorting method comprising:
transferring a chip on a wafer to a tray by a pick-and-place head; and
examining a chip surface of said chip by an image capture device.

20. The chip sorting method according to claim 19, wherein said image capture device is a CCD (Charge Coupled Device).

21. The chip sorting method according to claim 20, wherein said CCD has 1.3 million pixels.

22. The chip sorting method according to claim 19, further comprises an auxiliary light source disposed around said image capture device so as to light up said chip surface.

23. The chip sorting method according to claim 22, wherein said auxiliary light source is a LED light source.

24. The chip sorting method according to claim 23, wherein said LED light source is a blue light source.
